(19) United States
(12) Patent Application Publication
(10) Pub. No.: US 2017/0028906 A1
(43) Pub. Date: Feb. 2, 2017

(54) BRAKING SYSTEM WITH VARIABLE BRAKE LIGHTS

(71) Applicant: Patrick Beach, Menasha, WI (US)

(72) Inventor: Patrick Beach, Menasha, WI (US)

(21) Appl. No.: 14/814,683

(22) Filed: Jul. 31, 2015

(51) Int. Cl. B60Q 1/44

(52) U.S. Cl. CPC B60Q 1/444; B60Q 1/441

(57) ABSTRACT

A braking system for indicating brake pad application that includes: a brake lever; a brake pad at the distal end of the brake lever; and a pressure detector connected to the brake lever, where the pressure detector detects pressure applied to the brake pad. A plurality of wire leads extends from the pressure detector and connected to the brake lever. The braking system includes a means to vary brake light illumination based upon pressure detected by the pressure detector providing three levels of illumination. A first brake illumination indicates a normal brake pressure application; a second brake illumination indicates a second level of brake pressure at a higher intensity than the normal brake pressure; and a third brake illumination indicates a third level of brake pressure at a highest intensity of brake pressure.

### BACKGROUND OF THE INVENTION

Field of Invention

The present invention relates to a braking system that detects brake pedal pressure and adjusts brake lighting based upon the brake pressure.

Description of Related Art

All motor vehicles include braking systems to bring the vehicle to a stop as needed. The braking systems typically include a brake pad that is depressed by a driver's foot. During normal operation, when the brake pad is depressed brake lights illuminate to alert any following vehicles of the driver's depression of the brake pad and therefore the deceleration of the vehicle. However one drawback to the conventional brake light system is that the drivers that are behind the stopping vehicle are not aware of the intensity that the brake is being pressed. Therefore the following driver can't anticipate how fast the vehicle is decelerating, i.e., if an immediate stop is occurring or if the vehicle is merely just slowing down momentarily. As a result, it would be advantageous to have a system that provided more information to a following driver with respect to the braking vehicle.

### SUMMARY OF THE INVENTION

The present invention relates to a braking system for indicating brake pad application that includes: a brake lever; a brake pad at the distal end of the brake lever; and a pressure detector connected to the brake lever, where the pressure detector detects pressure applied to the brake pad. A plurality of wire leads extends from the pressure detector and connected to the brake lever. The braking system includes a means to vary brake light illumination based upon pressure detected by the pressure detector providing three levels of illumination. A first brake illumination indicates a normal brake pressure application; a second brake illumination indicates a second level of brake pressure at a higher intensity than the normal brake pressure; and a third brake illumination indicates a third level of brake pressure at a highest intensity of brake pressure.

### BRIEF DESCRIPTION OF DRAWINGS

FIG. 1 depicts a brake system according to the present invention that provides braking intensity information to a following driver.

### DETAILED DESCRIPTION

The present invention relates to a system that provides braking intensity information to approaching vehicles based upon the degree of brake pedal depression by a driver. Typically a driver of a motor vehicle depresses a brake pedal and then a brake light is displayed on the rear of the vehicle. However, the present invention varies the intensity of the brake light based upon the pressure applied to the brake pad. The brake system of present invention depends on the pressure applied to the pad. If normal pressure is applied to the brake pad by the driver a steady brake light is displayed on the rear of the vehicle. If a more intense application of pressure is applied to the brake pad then then the brake pad flashes and this flashing can vary even further based upon the intensity of the pressure. The present invention contemplates pressure over a percentage range of brake pressure application. Light pressure or normal brake pressures relates to a 0 to 40 percent range of brake pressure application. A more intense pressure is associated with a 40 percent to 80 percent range of pressure and the highest intensity of pressure anything above 85 percent. In the mid-range the brake lights will flash four times per second indicating a more intense stopping situation. In the highest intensity range above 85 percent the brake lights flash at a rate of 10 flashes per second. The highest intensity alerts the following vehicle that the driver is jamming on the brakes and therefore is coming to an abrupt stop.

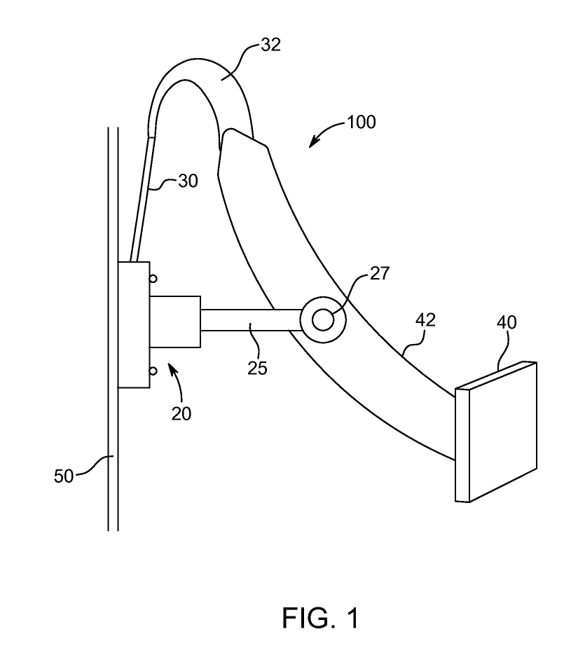

In reference to FIG. 1, a brake system in accordance with the present invention is depicted. In particular, this brake system includes brake pad 40 with a lever 42. A pressure detector 20 is connected to the lever 42 by a bolt 27. Further a wire harness 30 extends from the pressure detector 20 with wire leads 32 connected to the brake lever 42. The pressure detector 20 is mounted on a firewall 50 on the interior of the vehicle. The mechanical aspects of the present invention are depicted in FIG. 1. The system includes a brake light system that is controlled based upon readings indicated by the pressure detector 20. Normal brake pressure from a 0 to 40 percent range will trigger a normal up brake light illumination. A mid-range of more intense brake pressure from the 40 to 85 percent rage triggers a flashing of the brake lights at four flashes per second. The highest intensity of brake pressure triggers brake light flashing at ten flashes per second.

As a result the present invention relays more information with respect to the brake pad application by a driver through the varying of brake light illumination. This additional information helps following vehicles to come to a stop at an appropriate time to avoid any rear-end accidents. The instant invention has been shown and described in what it considers to be the most practical and preferred embodiments. It is recognized, however, that departures may be made there from within the scope of the invention and that obvious modifications will occur to a person skilled in the art.

What is claimed is:

1. A braking system for indicating brake pad application comprising:
a. a brake lever;
b. a brake pad at the distal end of the brake lever;
c. a pressure detector connected to the brake lever, where the pressure detector detects pressure applied to the brake pad;
d. a plurality of wire leads extending from the pressure detector and connected to the brake lever;
e. a means to vary brake light illumination based upon pressure detected by the pressure detector; and
f. a first brake illumination, where the first brake illumination indicates a normal brake pressure application;
g. a second brake illumination, where the second brake illumination indicates a second level of brake pressure at a higher intensity than the normal brake pressure; and
h. a third brake illumination, where the third brake illumination indicates a third level of brake pressure at a highest intensity of brake pressure.

2. The braking system according to claim 1, where the first brake illumination provides a steady brake light.

3. The braking system according to claim 1, where the second brake illumination provides a brake light comprising four flashes per second.

4. The braking system according to claim 1, where the third brake illumination provides a brake light comprising 10 flashes per second.

5. The braking system according to claim 1, where the first brake illumination indicates brake pressure up to 40%.

6. The braking system according to claim 1, where the second brake illumination indicates brake pressure greater than 40% up to 85%.

7. The braking system according to claim 1, where the third brake illumination indicates brake pressure greater than 85%.
